(19) United States
(12) Patent Application Publication
(10) Pub. No.: US 2006/0193250 A1
(43) Pub. Date: Aug. 31, 2006

(54) Methods, systems and computer program products for thermal management of a processor associated with a network interface

(75) Inventors: Chris Desjardins, Raleigh, NC (US); John Hildebrand, Hillsborough, NC (US); Komal Khungar, Morrisville, NC (US); Robert Kress, Raleigh, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/068,290

(22) Filed: Feb. 28, 2005

(51) Int. Cl. H04J 3/14; H04J 1/16

(52) U.S. Cl. 370/219; 370/252

(57) ABSTRACT

Methods, systems, and computer program products for thermal management of a processor associated with a network interface are disclosed. According to one method, message traffic is sent and received using a first processor associated with a first network interface. A temperature associated with the first processor is determined. Message traffic is switched from the first processor to a second processor in response to the temperature associated with the first processor having a predetermined relationship with respect to a threshold value. The threshold value can be less than a thermal shutdown level of the first processor.

### TECHNICAL FIELD

The subject matter described herein relates to network interfaces. More particularly, the subject matter described herein relates to methods, systems, and computer program products for thermal management of a processor associated with a network interface.

### BACKGROUND ART

In telecommunications networks, nodes terminate links that carry message traffic, such as signaling and voice data. For example, in a signaling system 7 (SS7) telecommunications network, signal transfer point (STP) nodes terminate SS7 signaling links that carry signaling data. An STP node can include a plurality of network interface modules for terminating a plurality of signaling links. Each network interface module may include one or more processors for managing the transmission and receipt of message traffic over its links. For example, a network interface module may include an application processor operable to perform suitable communications functions, such as SS7 protocol functions, for the communication of signaling data. Alternatively, an application processor of a network interface module can implement Internet protocol (IP) functions for communicating with IP links.

High speed links can place a heavy burden on processors sending and receiving the message traffic over these links. For example, a link interface module may terminate many high speed links. The application processor on the link interface module must send and receive data over the high speed links at line rates or near line rates to avoid excessive buffering of signaling messages. Such processing can cause the temperature of the application processor to increase.

Some commercially available microprocessors are equipped with temperature managing mechanisms. These processors typically include a thermal sensor and a thermal control circuit (TCC) provided on the die to measure the temperature of the die. When the measured value exceeds a threshold value, the TCC reduces power consumption by periodically and repeatedly pausing processes internal to the processor core at a given cycle, and lowers the temperature by reducing the amount of heat generated. A processor may also completely shut down when its temperature level is above a second threshold value to a void damage to the chip. In addition, processors may provide a thermal warning to an operator when the processor temperature reaches or exceeds a threshold value. In a telecommunications environment, the stopping or shutting down of processors for managing message traffic is undesirable because message traffic on its associated link may be lost. Further, message traffic may be slowed or stopped.

In order to reduce the likelihood of the processor overheating in a signal transfer point, mechanical devices, such as fans, have been provided to cool the processors. Unlike personal computers where fans can be located on or adjacent to a processor, in high speed telecommunications equipment, such location is not possible due to close spacing of the link interface module. Accordingly, tray fans may be located above or below groups of link interface modules to control the processor temperature of the link interface module. Even though such fan banks or trays provide a mechanical mechanism for controlling processor temperature, overheating can still occur in light of the high processing mode on some processors. If overheating occurs and results in processor shutdown, signaling traffic will be lost and calls and call set up attempts may be interrupted.

Accordingly, there exists a need for methods, systems, and computer program products for providing thermal management of signaling link over network interface modules in a manner that prevents or reduces message traffic loss due to processor temperature.

### SUMMARY

According to one aspect, the subject matter described herein includes methods, systems, and computer program products for thermal management of a processor associated with a network interface. A method for such thermal management of a network interface may include sending and receiving message traffic using a first processor associated with a first network interface. The message traffic may include, for example, signaling data, voice data, video data, non-voice audio data, and/or user data that is communicated on an SS7 signaling link, IP signaling link, or a voice over IP channel. Further, the method may include determining a temperature associated with the first processor. The temperature may be determined by a thermal sensor. The method may also include switching the message traffic from the first processor to a second processor in response to the temperature associated with the first processor having a predetermined relationship with respect to a threshold value. The threshold value can be less than a thermal shutdown level of the processor. As a result, message traffic is not lost due to a thermal shutdown of the processor because message traffic is switched to the second network interface prior to the processor temperature rising above the shutdown temperature.

The methods and systems described herein for thermal management of a processor associated with the network interface may be implemented as a computer program product comprising computer executable instructions embodied in a computer readable medium. Exemplary computer readable media suitable for implementing the subject matter described herein includes microprocessors that execute memory stored on chip memory devices, disc memory devices, or other suitable memory devices, applications specific integrated circuits, reconfigurable logic devices, and downloadable electrical systems.

### BRIEF DESCRIPTION OF THE DRAWINGS

Preferred embodiments of the subject matter described herein will now be explained with reference to the accompanying drawings of which:

FIG. 1 is a block diagram illustrating an exemplary STP architecture including interface module thermal management applications according to an embodiment of the subject matter described herein;

FIG. 2 is a block diagram of an exemplary internal architecture of an interface module including a thermal management application according to an embodiment of the subject matter described herein;

FIG. 3 is a flow chart of a process implemented by a callback function for managing a thermal indicator parameter according to an embodiment of the subject matter described herein;

FIG. 4 is a flow chart of a process implemented by a thermal management application for controlling an SS7 management module to switch message traffic according to an embodiment of the subject matter described herein;

FIGS. 5A-5D are a flow chart of a process implemented by an SS7 management module for blocking links of an interface module according to an embodiment of the subject matter described herein;

FIGS. 6A-6D are a flow chart of a process implemented by an SS7 management module for unblocking links of an interface module according to an embodiment of the subject matter described herein;

FIG. 7 is a flow chart of a process of a blocking function according to an embodiment of the subject matter described herein;

FIGS. 8A-8B are a flow chart of a process of an unblocking function according to an embodiment of the subject matter described herein;

FIG. 9 is a flow chart of a process for activating a link of an interface module according to one embodiment of the subject matter described herein; and

FIG. 10 is a flow chart of a process for indicating the occurrence of link blocking or unblocking to an operations, administration, and maintenance module according to an embodiment of the subject matter described herein.

### DETAILED DESCRIPTION

Methods, systems, and computer program products for thermal management of a processor associated with a network interface according to embodiments of the subject matter described herein may be implemented in any suitable network communications device, such as a signal transfer point (STP), an IP router, a media gateway, or any other device that sends and receives packetized telecommunications signaling and/or voice data. In one exemplary implementation, the network communications device includes first network interface for sending and receiving message traffic over a network and first processor associated with the first network interface module for controlling the sending and receiving of the message traffic over the first network interface. The message traffic may include any suitable type of traffic such as signaling data, voice data, video data, non-voice audio data, and/or user data communicated on a telecommunications link such as an SS7 signaling link or an IP link. The network communications device may also include a second processor configured to control the sending and receiving of message traffic over a network. Further, the network communications device can include a temperature sensor for sensing a temperature associated with the first processor. Further, the network communications device may include a thermal management application associated with the temperature sensor and the first processor for determining whether the temperature has a predetermined relationship with respect to a threshold value. In response to determining that the temperature has a predetermined relationship with respect to a threshold value, the thermal management application switches message traffic from the first processor to the second processor.

As stated above, the thermal shutdown of a processor handling message traffic can result in a loss of messages or a reduction in the transmission rate of the traffic. The subject matter described herein can prevent or reduce the effect of the thermal shutdown on message traffic. In one exemplary implementation, a network interface device according to the subject matter described herein switches message traffic away from a first processor when the temperature level of the first processor is above a temperature threshold value. The network traffic can be switched to a second processor such that communication of message traffic is not disrupted. When the temperature of the first processor falls below the temperature threshold value, message traffic can be switched back to the first processor from the second processor. The temperature threshold value can be set less than the thermal shutdown level of the first processor such that message traffic can be efficiently switched prior to shutdown of the first processor.

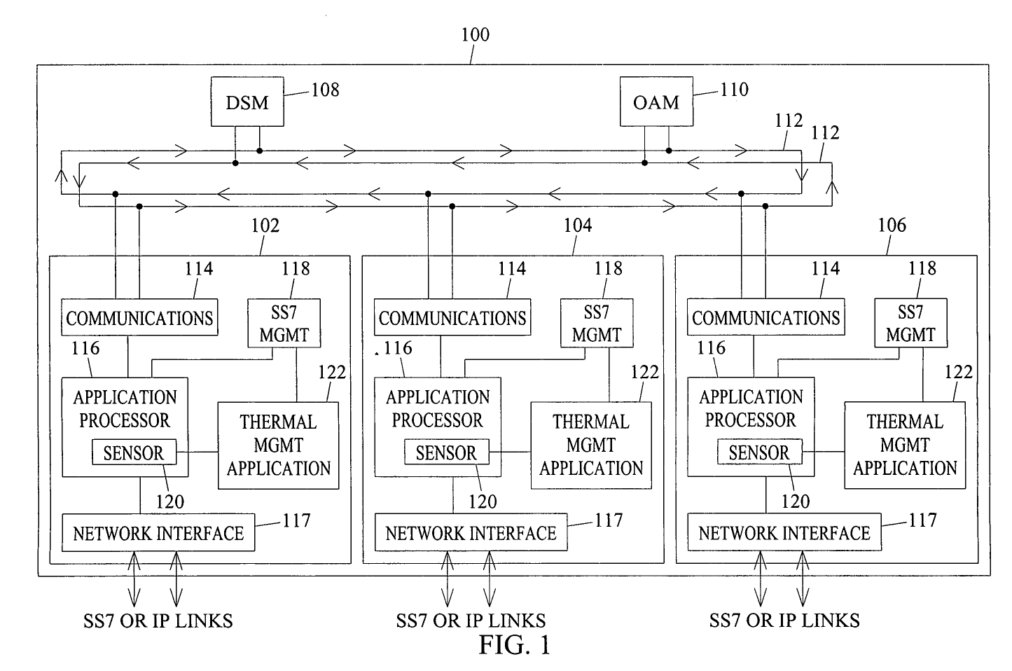

FIG. 1 illustrates an exemplary STP architecture including one or more thermal management applications according to an embodiment of subject matters described herein. Referring to FIG. 1, STP 100 includes a plurality of network interface devices, referred to as high capacity multiport link interface modules (HCMIMs) 102, 104, and 106, for interfacing with communications links, such as SS7 or IP links, that carry message traffic. In the illustrated embodiment, each HCMIM 102, 104, and 106 includes a plurality of ports, each capable of bidirectional SS7 or IP communications.

STP 100 may also include one or more internal processing modules, such as a database service module (DSM) 108 and an operations administration and maintenance (OAM) module 110 that do not interface directly with external communications links. For example, DSM 108 may provide database-related services, such as global title and number portability translations. OAM module 110 may perform database provisioning and manage the overall operation of STP 100. Each of DSM 108 and OAM module 110 may be a printed circuit board with one or more processors mounted thereon. In one exemplary implementation, DSM 108 and OAM module 110 may each include an application processor for executing application programs and a communications processor for communicating with each other and HCMIMs 102, 104, and 106. Modules 102, 104, 106, 108, and 110 may be connected by one or more buses 112 for providing interprocessor communications. In the illustrated example, buses 112 comprise a pair of counter-rotating dual rings. In an alternate implementation, buses 312 may be replaced by an Ethernet LAN.

HCMIMs 102, 104, and 106 may each include a communications processor 114, an application processor 116, a network interface 117, and an SS7 management module 118. Each communications processor 114 is operable to provide communications among the HCMIMs and with DSM 108 and OAM module 110. Each application processor 116 and network interface 117 is operable to send and receive message traffic on corresponding links. For example, each application processor 116 is operable to execute SS7 functions stored in its corresponding SS7 management module 118. The SS7 functions include instructions for implementing SS7 processes for sending and receiving signaling messages over SS7 signaling links.

As stated above, methods, systems, and computer program products according to the subject matter described herein can switch message traffic from an application processor of a first network interface module to an application processor of a second network interface module when the temperature level of the application processor of the first network interface module is greater than or equal to a threshold value. For example, the message traffic associated with application processor 116 of HCMIM 102 can be switched to application processor 116 or HCMIM 104 when the temperature of application processor 116 of HCMIM 102 is greater than or equal to the threshold value. According to one embodiment, HCMIMs 102, 104, and 106 may each include a temperature sensor 120 for measuring the temperature of application processor 116. Each of HCMIMs 102, 104, and 106 can also include a thermal management application 122 for determining whether the measured temperature is greater than or equal to the threshold value. Temperature sensor 120 can be a component of application processor 116, which includes a register for storing the measured temperature. Thermal management application 122 can monitor the register and determine whether the temperature is greater than or equal to a stored threshold value. In response to determining that the temperature is greater than or equal to the threshold value, thermal management application 122 can control the switching of message traffic to HCMIM 104 or HCMIM 106. The threshold value may be set to a temperature less than the shutdown temperature of application processor 116. In this manner, traffic can be switched to another HCMIM before application processor 116 shuts down due to temperature.

The subject matter described herein is not limited to switching message traffic from an application processor on one interface module to application processor on another interface module when the temperature of the application processor on the first interface module exceeds the threshold value. In an alternative implementation, multiple application processors may be located on the same network interface module. In such an implementation, the thermal management application 122 may switch message traffic from a first application processor on a first interface module to a second application processor on the first interface module. Similarly, the subject matter described herein is not limited to switching message traffic to a new network interface when the temperature of an application processor exceeds a threshold. For example, multiple application processors may be associated with the same network interface. In such an implementation, thermal management application may switch message traffic from an overheated application processor to another application processor associated with the same network interface.

After message traffic is switched from an HCMIM, the temperature of the application processor of the HCMIM may reduce because of the reduction in load on the processor. When the processor reaches a temperature below a threshold value, message traffic may be switched back to the HCMIM after a predetermined time period. For example, message traffic can be switched from HCMIM 104 to HCMIM 102 when the temperature of HCMIM 102 falls below the threshold value for a predetermined time period. In order to determine whether to switch back from HCMIM 102, thermal management application 122 of HCMIM 102 can determine whether the temperature measured by temperature sensor 120 is less than the threshold value. In response to determining that the temperature of application processor 116 of HCMIM 102 is less than the threshold value for the predetermined time period, thermal management application 122 of HCMIM 102 can control the switching of message traffic back to HCMIM 102. In this manner, traffic can be switched back to HCMIM 102 when application processor 122 of HCMIM 102 is consistently below its shutdown temperature. The predetermined time period can be a suitable time period (e.g., one second) such that application processor 122 is at a stable temperature below the processor shutdown temperature.

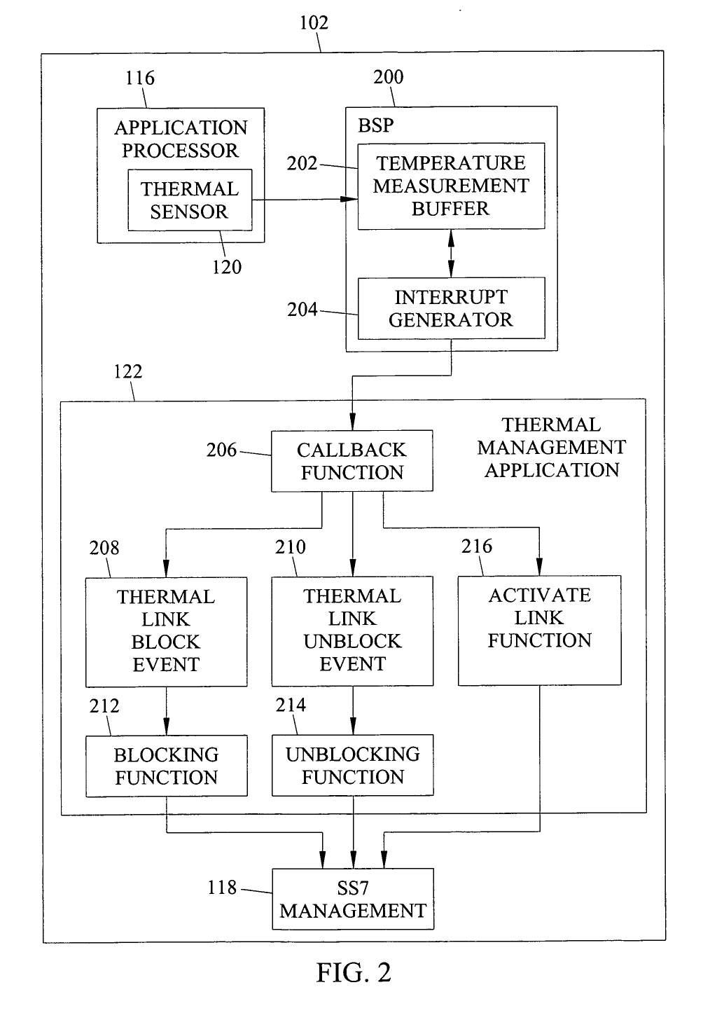

FIG. 2 is a block diagram illustrating exemplary internal architecture of HCMIM 102 according to an embodiment of the subject matter described herein. In FIG. 2, HCMIM 102 can include a board service package (BSP) 200 for receiving temperature measurements from thermal sensor 120. For example, BSP 200 can poll a register of application processor 116 storing a temperature measurement of application processor 116. As stated above, thermal sensor 120 is operable to measure the temperature of application processor 116. BSP 200 can store the temperature measurement in a temperature measurement buffer 202.

An interrupt generator 204 of BSP 200 can continuously monitor the temperature measurement within buffer 202. If the temperature measurement rises above than a threshold value, interrupt generator 204 can generate an interrupt to a callback function 206 within thermal management application 122. The threshold value can be set to a temperature below the shutdown temperature of application processor 116. Thus, an interrupt can be generated at a threshold value below the shutdown temperature. Interrupt generator 204 can also generate an interrupt when the temperature measurement falls below a second threshold value.

According to one embodiment, interrupt generator 204 can pass a “THERM_STATE” parameter to callback function 206 of thermal management application 122 for indicating an ONSET condition or an ABATEMENT condition. The ONSET condition indicates that the temperature of application processor 116 is rising above the threshold value. The ABATEMENT condition indicates that the temperature of application processor 116 is falling below the threshold value. The “THERM_STATE” parameter may be set to 1 for indicating the ONSET condition. In addition, the “THERM_STATE” parameter may be set to 0 for indicating the ABATEMENT condition.

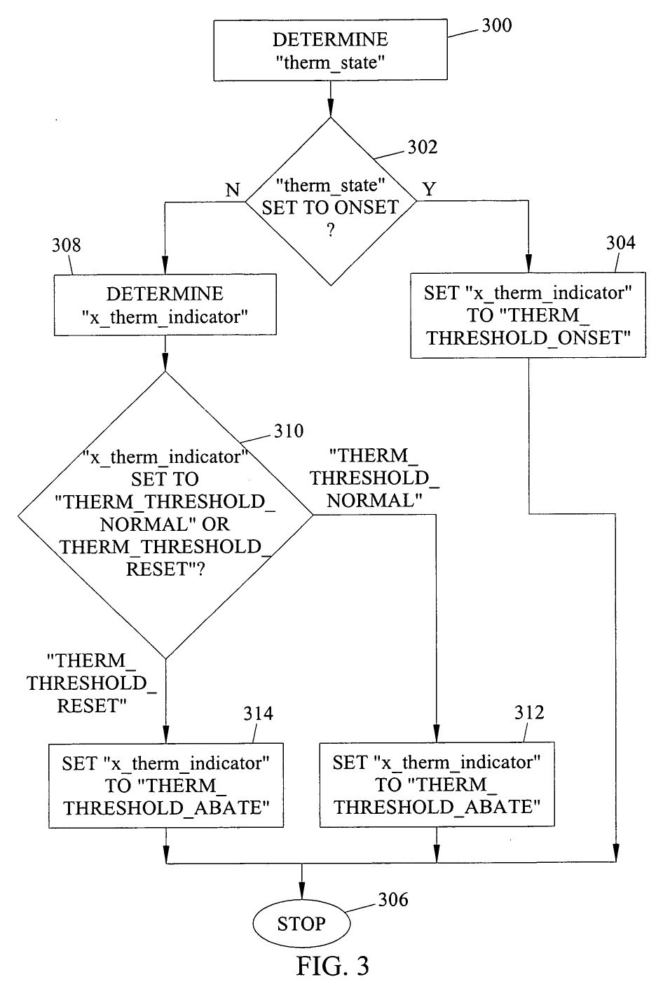

Callback function 206 may manage a thermal indicator parameter, designated “x_therm_indicator” parameter, for indicating an ONSET condition or an ABATEMENT condition. Callback function 206 may continuously run and check the “THERM_STATE” parameter generated by interrupt generator 204 for updating the thermal indicator parameter. FIG. 3 is a flow chart illustrating a process implemented by callback function 206 for managing the “x_therm_indicator” parameter according to an embodiment of the subject matter described herein. Referring to FIG. 3, the process starts at step 300 when callback function 206 is called by interrupt generator 204. At step 300, callback function 206 determines the condition of “THERM_STATE” parameter. Next, at step 302, callback function 206 determines whether the “THERM_STATE” parameter indicates an ONSET condition. If the “THERM_STATE” parameter indicates the ONSET condition, the process proceeds to step 304. At step 304, the “x_therm_indicator” parameter is set to “THERM_THRESHOLD_ONSET” for indicating that the threshold value of application processor 116 has been exceeded. Next, the process stops at step 306.

Referring again to step 302, if the “THERM_STATE” parameter is not set to the ONSET condition, the process proceeds to step 308. At step 308, callback function 206 determines the condition of the “x_therm_indicator” parameter. Next, at step 310, it is determined whether the “x_therm_indicator” parameter is set to the “THERM_THRESHOLD_NORMAL” condition or the “THERM_THRESHOLD_RESET” condition. The “THERM_THRESHOLD_NORMAL” condition indicates that application processor 116 is currently at a normal operating temperature below the threshold value. The “THERM_THRESHOLD_RESET” condition indicates that an operator has reset the temperature of application processor 116 to a nominal operating condition. If the “x_therm_indicator” parameter is set to the “THERM_THRESHOLD_NORMAL” condition, the “x_therm_indicator” parameter is set to “THERM_THRESHOLD_ABATE” (step 312) and the process stops (step 306). On the other hand, if the “x_therm_indicator” parameter is set to the “THERM_THRESHOLD_RESET” condition, the “x_therm_indicator” parameter is set to “THERM_THRESHOLD_ABATE” (step 314) and the process stop (step 306). Otherwise, if the “x_therm_indicator” parameter is neither “THERM_THRESHOLD_RESET” nor “THERM_THRESHOLD_NORMAL”, the process stops at step 306.

On updating the “x_therm_indicator” parameter, a message may be sent to an SS7 management module 118 for switching message traffic on the links of application processor 116. For example, thermal management application 122 can control SS7 management module 118 to block traffic on the links of HCMIM 102 and start switching traffic from application processor 116 to another application processor when the “x_therm_indicator” parameter is set to the “THERM_THRESHOLD_ONSET” condition. Further, for example, thermal management application 122 can control module 118 to unblock the message traffic of application processor 116 and start switching traffic from another application processor to application processor 116 when the “x_therm_indicator” parameter is set to the “THERM_THRESHOLD_ABATE” condition. According to one embodiment, thermal management application 122 can execute a process checking the “x_therm_indicator” parameter at least once every heartbeat. For example, the “x_therm_indicator” parameter may be checked once every 5 milliseconds (ms).

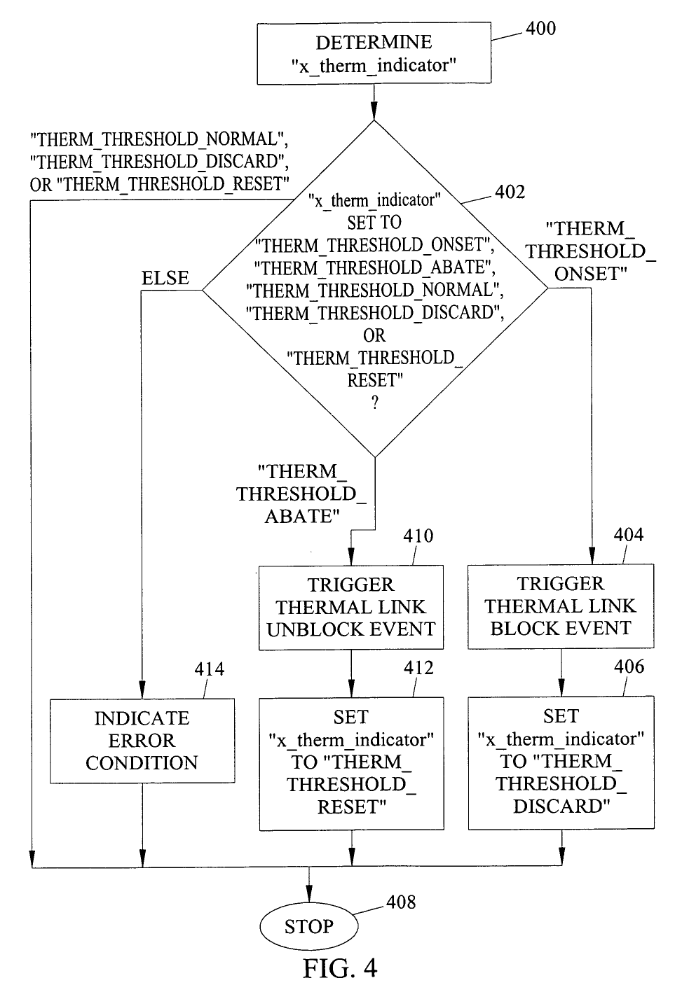

FIG. 4 is a flow chart illustrating a process implemented by thermal management application 122 for controlling SS7 management module 118 to switch message traffic according to an embodiment of the subject matter described herein. The process may run periodically for checking the condition of the “x_therm_indicator” parameter. Referring to FIG. 4, the process starts at step 400 where module 206 determines the condition of the “x_therm_indicator” parameter. Next, at step 402, module 208 determines whether the “x_therm_indicator” parameter is set to “THERM_THRESHOLD_ONSET”, “THERM_THRESHOLD_ABATE”, “THERM_THRESHOLD_NORMAL”, “THERM_THRESHOLD_DISCARD”, or “THERM_THRESHOLD_RESET”.

As stated above, a “THERM_THRESHOLD_ONSET” condition indicates that the temperature of application processor 116 is above the threshold value. If the “x_therm_indicator” parameter is set to “THERM_THRESHOLD_ONSET”, the process proceeds to step 404 where a thermal link block event (“PMTC_THERM_BLOCK_LNK” 208 shown in FIG. 2) of application 122 is triggered. Thermal management application 122 may trigger a thermal link block event by transmitting a level 3 SS7 management signal (L3) signal to SS7 management module 118 for initiating thermal link block event 208. Thermal link block event 208 initiates traffic switching from application processor 116 and link blocking on application processor 116, as described in more detail herein. Next, at step 406, the “x_therm_indicator” parameter is set to “THERM_THRESHOLD_DISCARD” for indicating that application processor 116 is in a thermal exceed condition or that its message traffic is being switched. The process can then stop at step 408.

As stated above, a “THERM_THRESHOLD_ABATE” condition indicates that the temperature of application processor 116 is less than the threshold value. If the “x_therm_indicator” parameter is set to “THERM_THRESHOLD_ABATE”, the process proceeds to step 410 where a thermal link unblock event (“PMTC_THERM_UNBLOCK_LNK” 212 shown in FIG. 2) within SS7 management module 118 is triggered. Thermal management application 122 may trigger a thermal link unblock event by transmitting an L3 signal to SS7 management module 118 for indicating the ONSET condition and initiating the thermal link unblock event 210. Thermal link unblock event 210 initiates traffic changeover to application processor 116 and link unblocking on application processor 116, as described in more detail herein. Next, at step 412, the “x_therm_indicator” parameter is set to “THERM_THRESHOLD_RESET” for indicating a thermal condition reset or that application processor 116 is in a normal condition. The process can then stop at step 408.

Referring again to step 402, if the “x_therm_indicator” variable is set to either “THERM_THRESHOLD_NORMAL”, “THERM_THRESHOLD_DISCARD”, or “THERM_THRESHOLD_RESET”, the process can stop at step 408. No action is necessary for these conditions.

Referring again to step 402, if the condition of the “x_therm_indicator” parameter is neither “THERM_THRESHOLD_ONSET”, “THERM_THRESHOLD_ABATE”, “THERM_THRESHOLD_NORMAL”, “THERM_THRESHOLD_DISCARD”, nor “THERM_THRESHOLD_RESET”, then the “x_therm_indicator” parameter is currently in an erroneous condition, and a debug error condition for the “x_therm_indicator” parameter is indicated by thermal management application 122 at step 414. Next, the process stops at step 408.

Referring to FIG. 2, thermal link block event (“PMTC_THERM_BLOCK_LNK”) 208 of thermal management application 122 can be triggered when thermal management application 122 transmits an L3 signal to SS7 management module 118 for indicating the ONSET condition. According to one embodiment, HCMIM 102 can include 64 links for sending and receiving message traffic. For an HCMIM having 64 links, thermal link blocking may be completed in batches of 8 links at a time until all of the links are blocked. After every eighth link, a 500 ms timer is started. At the end of the 500 ms, the timer triggers for continuing blocking link batches where it left off in the link blocking process until all of the links are blocked. By providing 500 ms between blocking the link batches, the functionality as provided by processors can be made available for other uses in between the time period required for blocking a link batch.

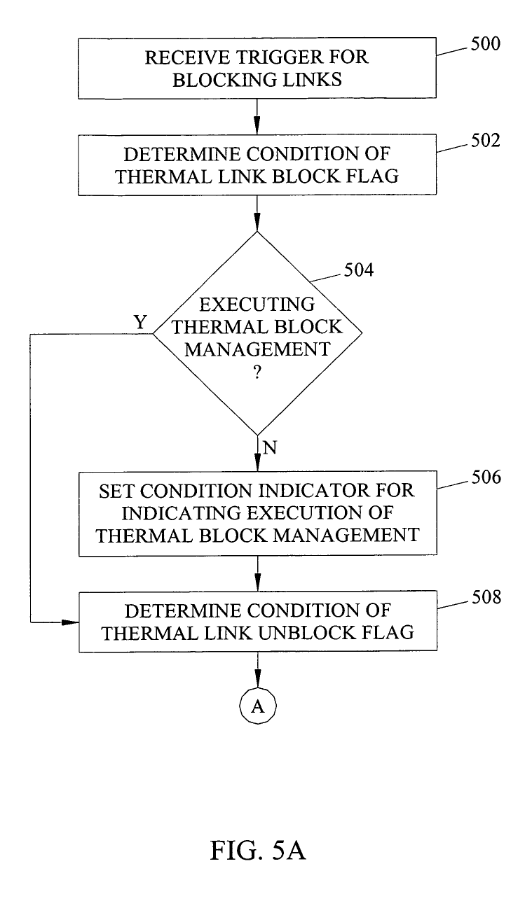

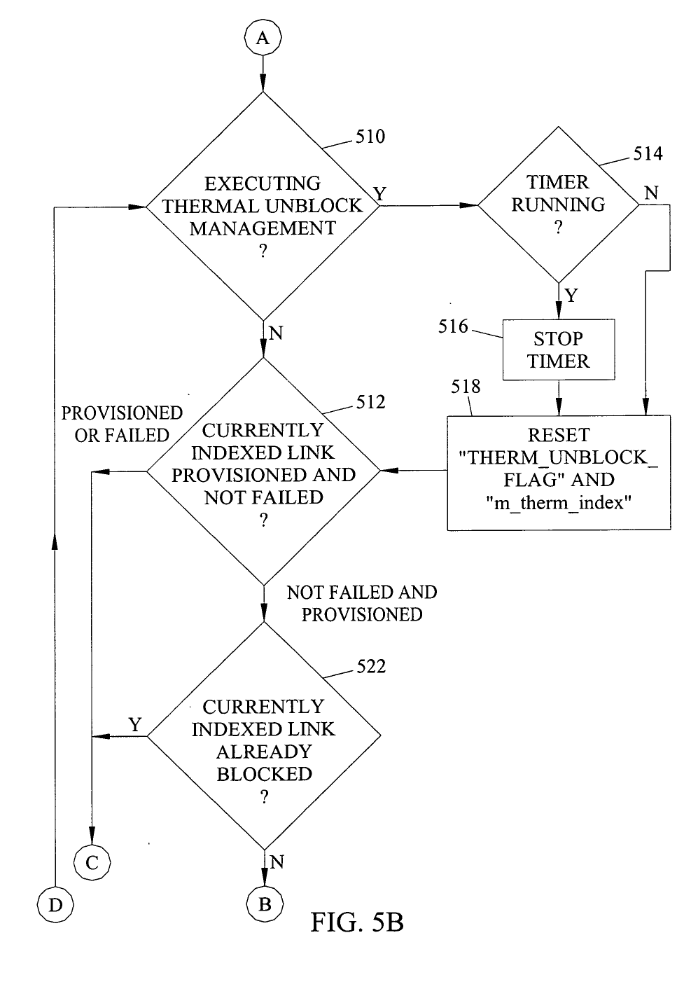

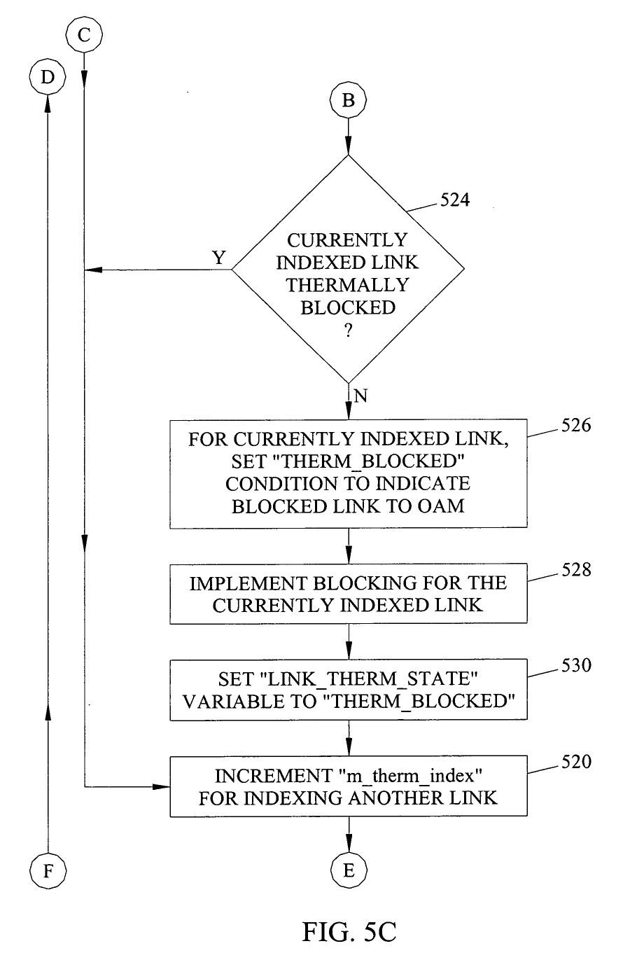

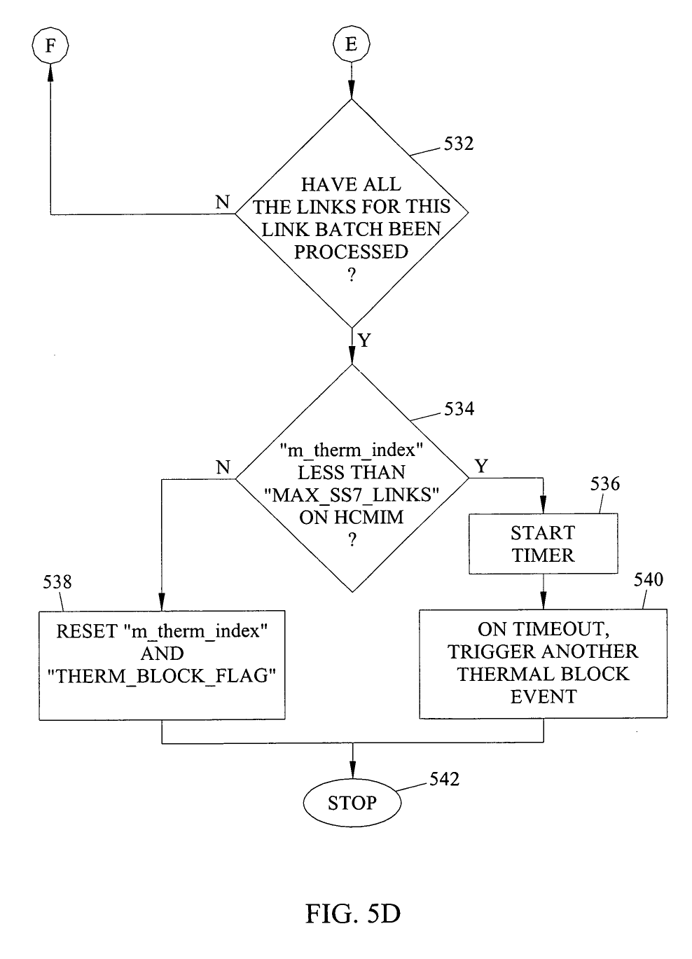

FIGS. 5A-5D are a flow chart illustrating a process implemented by SS7 management module 118 for blocking links of HCMIM 102 according to an embodiment of the subject matter described herein. As described herein, the links of HCMIM 102 can be blocked in batches. For example, HCMIM 102 can have 64 links, divided into 8 batches of 8 links. Batches can be blocked in batches separated by a time interval separated by a timer.

Referring to FIG. 5A, the process for blocking the links of HCMIM 102 can be initiated when thermal management application 122 triggers thermal block event 208 by sending an L3 signal indicating an ONSET condition (step 404 of FIG. 4). Referring to FIG. 5A, the process begins at step 500 where PMTC management module 208 receives the L3 signal trigger for blocking the links of HCMIM 102. Next, at step 502, thermal management application 122 determines a condition of “THERM_BLOCK_FLAG” parameter, which indicates whether module 118 is executing thermal link block management. At step 504, it is determined whether the “THERM_BLOCK_FLAG” parameter indicates that SS7 management module 118 is executing thermal link block management. If it is determined that module 118 is not executing thermal link block management at step 504, the “THERM_BLOCK_FLAG” parameter is set to a condition for indicating execution of thermal block management (step 506) and the process proceeds to step 508. Otherwise, if it is determined that the “THERM_BLOCK_FLAG” parameter indicates execution of thermal link block management at step 504, the process proceeds directly to step 508.

At step 508 of FIG. 5A, SS7 management module 118 determines a condition of “therm_unblock_flag” parameter, which indicates whether thermal management application 122 is executing thermal link unblock management. As stated above, thermal link unblock management can be implemented by thermal link unblock event 210. Next, at step 510 of FIG. 5B, it is determined whether the “THERM_UNBLOCK_FLAG” parameter indicates execution of thermal link unblock management. If it is determined that module 118 is not executing thermal link unblock management at step 510, the process proceeds to step 512. Otherwise, the process proceeds to step 514 where it is determined whether the 500 ms timer is running. If it is determined that the timer is running at step 514, the timer is stopped at step 516 and the “therm_unblock_flag” parameter is reset at step 518 to indicate that unblocking is not being implemented. Further, at step 518, an “m_therm_index” parameter indicating the start link index for thermal link management can be reset to 0 at step 518. The “m_therm_index” parameter” can indicate the link of HCMIM 102 that is currently being processed. The link index “m_therm_index” parameter is reset such that blocking can begin at the first link of HCMIM 102. Next, the process proceeds to step 512.

Next, beginning at step 512 of FIG. 5B, the process begins blocking the links of HCMIM 102. At each link of HCMIM 102, application 122 determines whether the currently indexed link is failed and provisioned (step 512). As stated above, the link index is indicated by the “m_therm_index” parameter. If the link is failed or not provisioned, the process proceeds to step 520, described in further detail herein. Otherwise, if the link is provisioned and not failed, the process proceeds to step 522.

At step 522, it is determined whether the currently indexed link is already blocked. The link may be blocked locally by an operator or blocked for other reasons due to temperature as described further herein. If the currently indexed link is already blocked, the process may proceed to step 520. Further processing of the link is not necessary because the link is already blocked. Otherwise, if the currently indexed link is not blocked, the process proceeds to step 524.

Next, at step 524 of FIG. 5C, it is determined whether a “LINK_THERM_STATE” variable for the currently indexed link is set to a “THERM_BLOCKED” condition indicating that the link is unblocked by operator input. If the currently indexed link is thermally blocked, the process may proceed to step 520. Otherwise, if the currently indexed link is not blocked, the process proceeds to step 526.

Next, at step 526, a “LINK_THERM_STATE” parameter for the currently indexed link is set to a “THERM_BLOCKED” condition for indicating to OAM 110 that the link is blocked. Upon notification of the condition, OAM 110 can implement blocking as described in further detail herein (step 528). According to one embodiment, OAM 110 can call a blocking function 212 (“PMTC_BLOCK_LNK_FUNC”) (shown in FIG. 2) for blocking the currently indexed link, as described in further detail below. In addition, OAM 110 can set up a buffer to store received message traffic during the operation of blocking function 212. Next, a “LINK_THERM_STATE” parameter is set to “THERM_BLOCKED” condition (step 530) for indicating that the link is currently blocked.

Next, the process proceeds to step 520 where the “m_therm_index” parameter is incremented by one for indexing another link. Next, at step 532 of FIG. 5D, it is determined whether all of the links for this link batch have been processed. If all of the links for this link batch have not been processed, the process proceeds back to step 512 for processing the currently indexed link, associated with the “m_therm_index” parameter incremented in step 520. Otherwise, if all of the links for this link batch have been processed, the process proceeds to step 534.

At step 534, it is determined whether the current index for the “m_therm_index” parameter is less than the maximum number of links (indicated by a “MAX_SS7_LINKS” parameter) on HCMIM 102. According to one embodiment, HCMIM 102 can have 64 links and therefore the maximum number of links is 64. If the current index is less than the maximum number of links, the process proceeds to step 536. Otherwise, the process proceeds to step 538.

Referring to step 536, the timer is reset to 0 and started. The timer may be set to timeout at 500 ms. After the timeout of the timer at step 536, another thermal link block event (“PMTC_THERM_BLOCK_LNK”) can be triggered (step 540). The process then stops at step 542.

At step 538, the “m_therm_index” and the “therm_block_flag” variables are reset. The process can then stop at step 542.

Referring again to FIG. 2, thermal link unblock event (“PMTC_THERM_UNBLOCK_LNK”) 210 can be triggered when thermal management application 122 transmits an L3 signal to SS7 management module 118 for indicating the ABATEMENT condition. As stated above, HCMIM 102 according to one embodiment can include 64 links for sending and receiving message traffic. Similar to the link blocking process of FIGS. 5A-5D, thermal link unblocking may be completed in batches of 8 links at a time until all of the links of HCMIM 102 are unblocked.

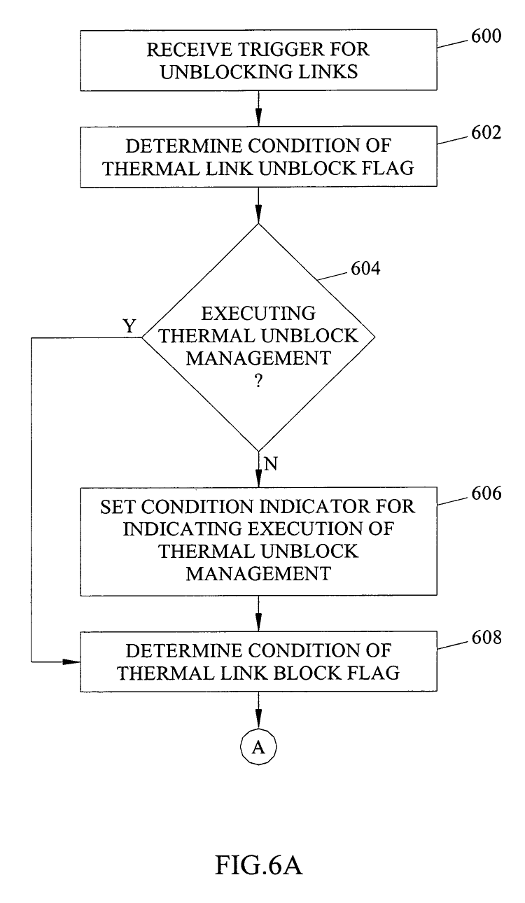

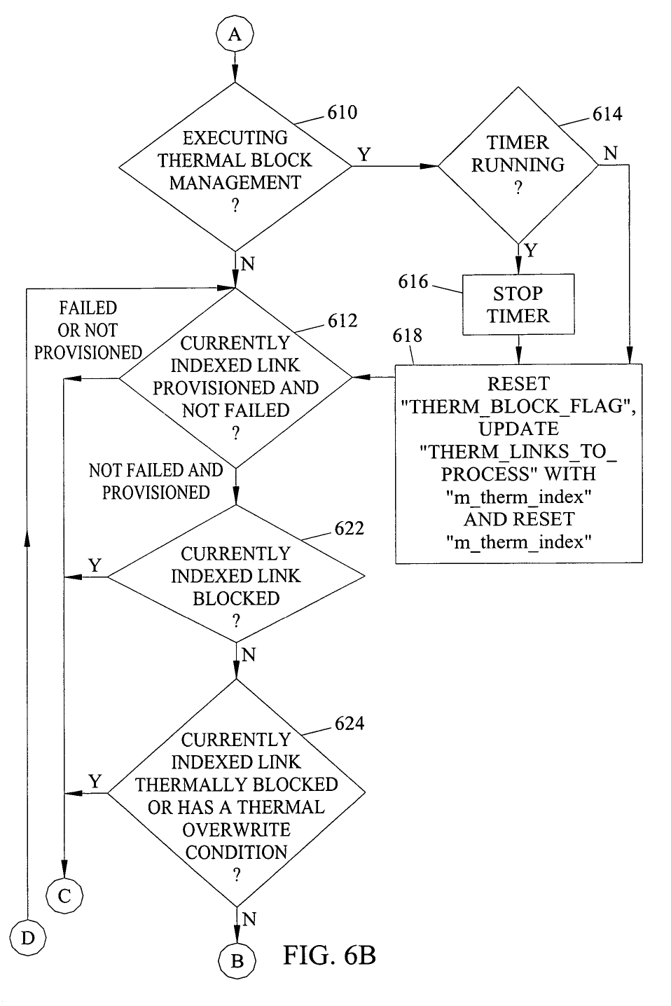

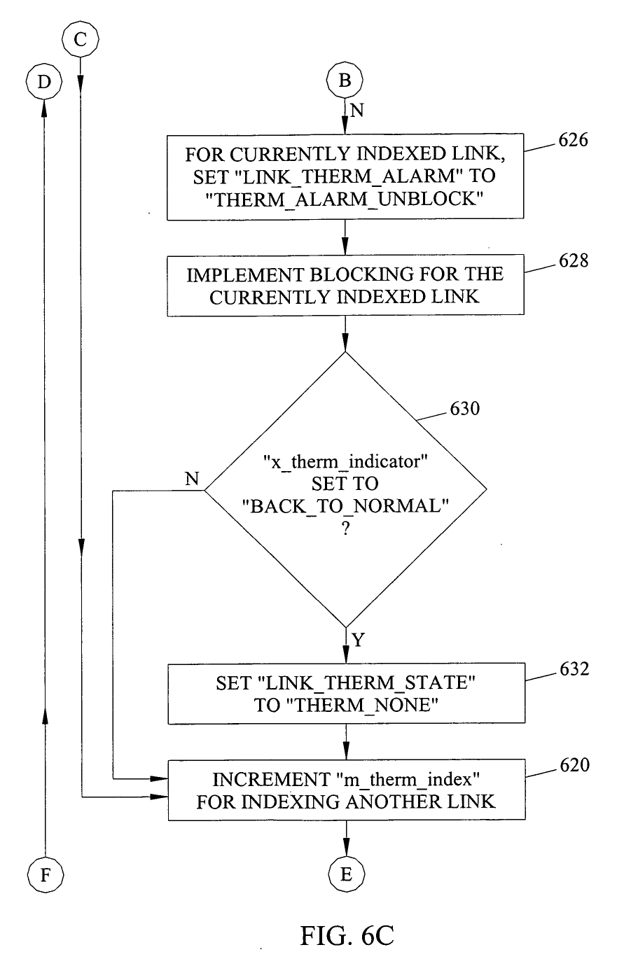

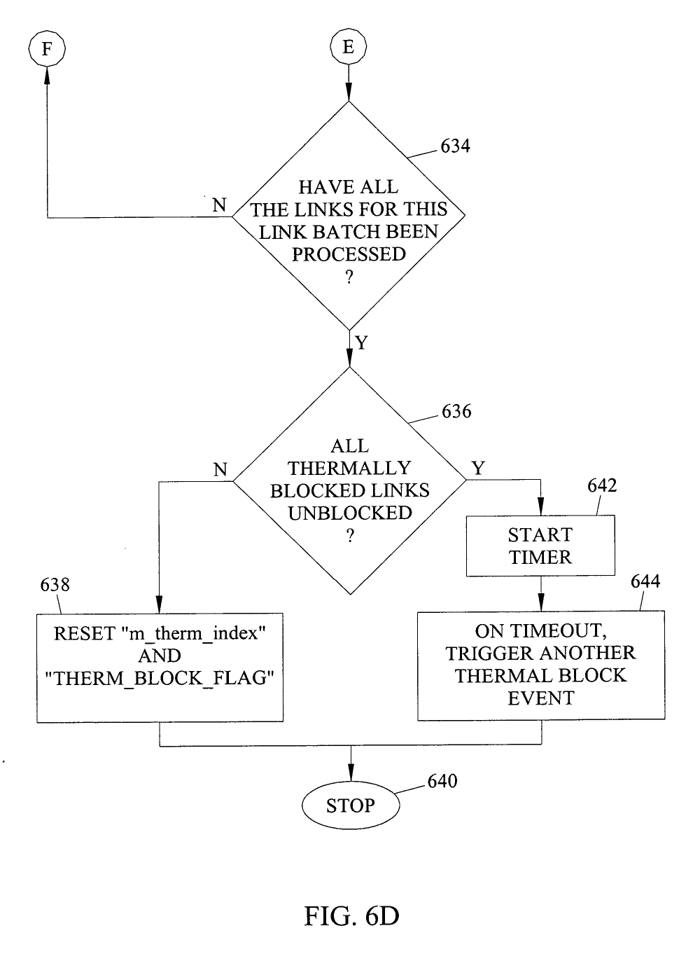

FIGS. 6A-6D are a flow chart illustrating a process implemented by SS7 management module 118 for unblocking links of HCMIM 102 according to an embodiment of the subject matter described herein. As described herein, the links of HCMIM 102 can be unblocked in batches. For example, HCMIM 102 can have 64 links, divided into 8 batches of 8 links. Batches can be unblocked in batches separated by a time interval separated by a timer.

Referring to FIG. 6A, the process for unblocking the links of HCMIM 102 can be initiated when thermal management application 122 triggers a thermal block event by sending an L3 signal indicating an ABATEMENT condition (step 410 of FIG. 4). Referring to FIG. 6A, the process begins at step 600 where SS7 management module 118 receives the L3 signal trigger for unblocking the links of HCMIM 102. Next, at step 602, SS7 management module 118 determines a condition of “THERM_UNBLOCK_FLAG” parameter, which indicates whether module 118 is executing thermal link unblock management. At step 604, it is determined whether the “THERM_UNBLOCK_FLAG” parameter indicates that SS7 management module 118 is executing thermal link unblock management. If it is determined that module 118 is not executing thermal link unblock management at step 604, the “THERM_UNBLOCK_FLAG” parameter is set to a condition for indicating execution of thermal unblock management (step 606) and the process proceeds to step 608. Otherwise, if it is determined that SS7 management module 118 is executing thermal link block management at step 604, the process proceeds directly to step 608.

At step 608 of FIG. 6A, SS7 management module 118 determines a condition of the “THERM_UNBLOCK_FLAG” parameter, which indicates whether SS7 management module 118 is executing thermal link block management. As stated above, thermal link block management can be implemented by thermal link unblock event 208. At step 610 of FIG. 6B, it is determined whether the “THERM_UNBLOCK_FLAG” parameter indicates that SS7 management module 118 is executing thermal link block management. If it is determined that module 118 is not executing thermal link block management at step 610, the process proceeds to step 612. Otherwise, the process proceeds to step 614 where it is determined whether the 500 ms timer is running. If it is determined that the timer is running at step 614, the timer is stopped at step 616 and the “THERM_UNBLOCK_FLAG” parameter is reset at step 618. Further, at step 618, a “THERM_LINKS_TO_PROCESS” variable is updated with the “m_therm_index” parameter, and the “m_therm_index” parameter indicating the start link index for thermal link management can be reset to 0 at step 618. Next, the process proceeds to step 612.

Next, beginning at step 612 of FIG. 6B, the process begins unblocking the links of HCMIM 102. At each link of HCMIM 102, application 122 determines whether the currently indexed link is not failed and provisioned (step 612). As stated above, the link index is indicated by the “m_therm_index” parameter. If the link is failed or not provisioned, the process proceeds to step 620, described in further detail herein. Otherwise, if the link is provisioned and not failed, the process proceeds to step 622.

At step 622, it is determined whether the currently indexed link is currently blocked. The link may be blocked locally by an operator or blocked for other reasons due to temperature as described further herein. If the currently indexed link is blocked, the process may proceed to step 620 of FIG. 6C. Otherwise, if the currently indexed link is not blocked, the process proceeds to step 624.

At step 624, it is determined whether the “LINK_THERM_STATE” parameter for the currently indexed link is set to a “THERM_BLOCKED” condition indicating that the link is thermally blocked or a “THERM_LOCAL_OVRWRT” condition indicating that the link that is thermally blocked is also manually blocked. If the currently indexed link is thermally blocked or has a thermal local overwrite condition, the process may proceed to step 620. Otherwise, if the currently indexed link is not blocked, the process proceeds to step 626 of FIG. 6C.

Next, at step 626, a “LINK_THERM_ALARM” parameter for the currently indexed link is set to a “THERM_ALARM_UNBLK” condition for indicating to OAM 110 that the link is unblocked. Upon notification of the condition, OAM 110 can implement unblocking as described in further detail herein (step 628). According to one embodiment, OAM 110 can call an unblocking function 214 (shown in FIG. 2) for unblocking the currently indexed link, as described in further detail below. In addition, OAM 110 can set up a buffer to store received message traffic during the operation of unblocking function 214.

Next, at step 630, it is determined whether the “x_therm_indicator” parameter is set to a “BACK_TO_NORMAL” condition indicating that the link has been unblocked. If the “x_therm_indicator” parameter is not set to the “BACK_TO_NORMAL” condition, the process proceeds to step 620. Otherwise, the “LINK_THERM”_STATE” parameter is set to a “THERM_NONE” condition indicating that the link which was thermally blocked is being blocked by an operator command (step 632). Next, the process proceeds to step 620.

Next, at step 620, the “m_therm_index” parameter is incremented by one for indexing another link. Next, at step 634 of FIG. 6D, it is determined whether all of the links for this link batch have been processed. If all of the links for this link batch have not been processed, the process proceeds back to step 612 for processing the currently indexed link, associated with the “m_therm_index” parameter incremented in step 620 of FIG. 6C. Otherwise, if all of the links for this link batch have been processed, the process proceeds to step 636.

At step 636, it is determined whether all of the thermally blocked links of HCMIM 102 have been unblocked. If all of the thermally blocked links have not been blocked, the “m_therm_index” parameter and the “THERM_UNBLOCK_FLAG” parameter are reset (step 638). The process can then stop at step 640.

If all of the thermally blocked links have been block the process proceeds to step 642 where the timer is reset to zero and started. The timer may be set to timeout at 500 ms. On the timeout of the timer at step 644, another thermal link block event can be triggered and the process of FIGS. 6A-6D may be initiated to process the next batch of links. The process then stops at step 640.

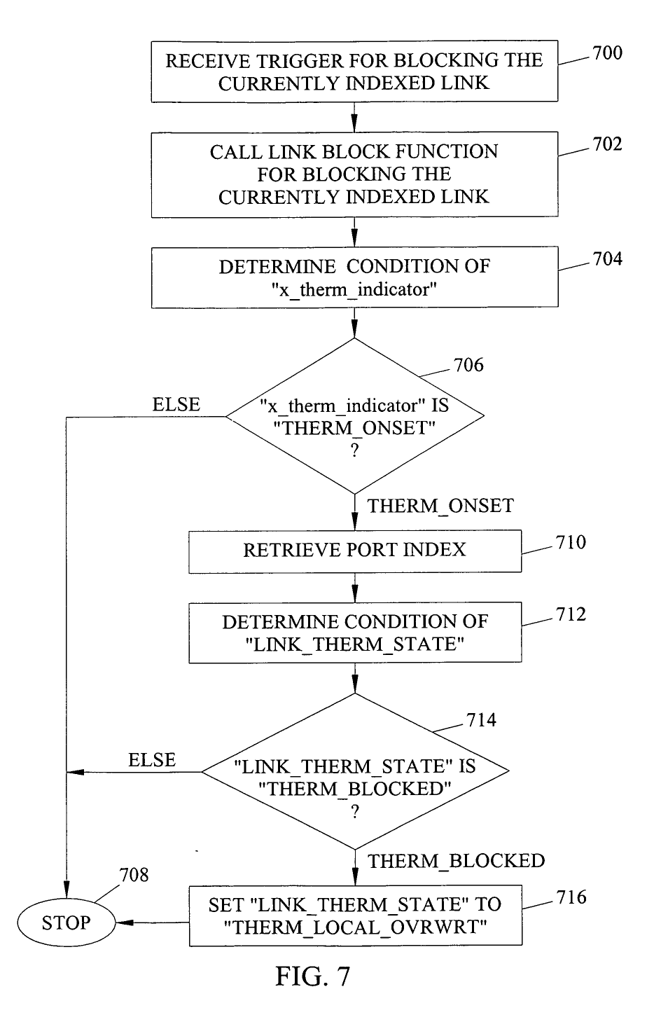

As stated above, blocking function 212 can be called for blocking a currently indexed link. When blocking function 212 is called, the currently indexed link can be blocked and associated thermal variables can be set. According to one embodiment, blocking function 212 is called at step 528 of FIGS. 5A-5D. FIG. 7 is a flow chart illustrating a process implemented when blocking function 212 is called according to an embodiment of the subject matter described herein. Referring to FIG. 7, the process for blocking a currently indexed link begins at step 700 where SS7 management module 118 receives an L3 signal trigger calling blocking function 212.

Next, at step 702, a link block function (“PMTC_BLOCK_LINK”) of SS7 management module 118 is called for blocking the currently indexed link. According to one embodiment, the link block function can block the link according to SS7 link changeover specifications.

At step 704, the condition of the “x_therm_indicator” parameter may be determined. It is determined whether the “x_therm_indicator” parameter is set to the “THERM_ONSET” condition (step 706). If the “x_therm_indicator” parameter is not set to the “THERM_ONSET” condition, the process proceeds to step 708 and stops. Otherwise, the process proceeds to step 710 where the port index for the currently indexed link is retrieved.

Next, at step 712, the condition of the “LINK_THERM_STATE” parameter is determined. It is determined whether the condition of the “LINK_THERM_STATE” parameter is “THERM_BLOCKED” (step 714). If the condition is not “THERM_BLOCKED”, the process proceeds to step 708 and stops. Otherwise, if the condition of the “LINK_THERM_STATE” parameter is “THERM_BLOCKED”, the “LINK_THERM_STATE” parameter is set to the “THERM_LOCAL_OVRWRT” condition at step 716. Next, the process stops at step 708.

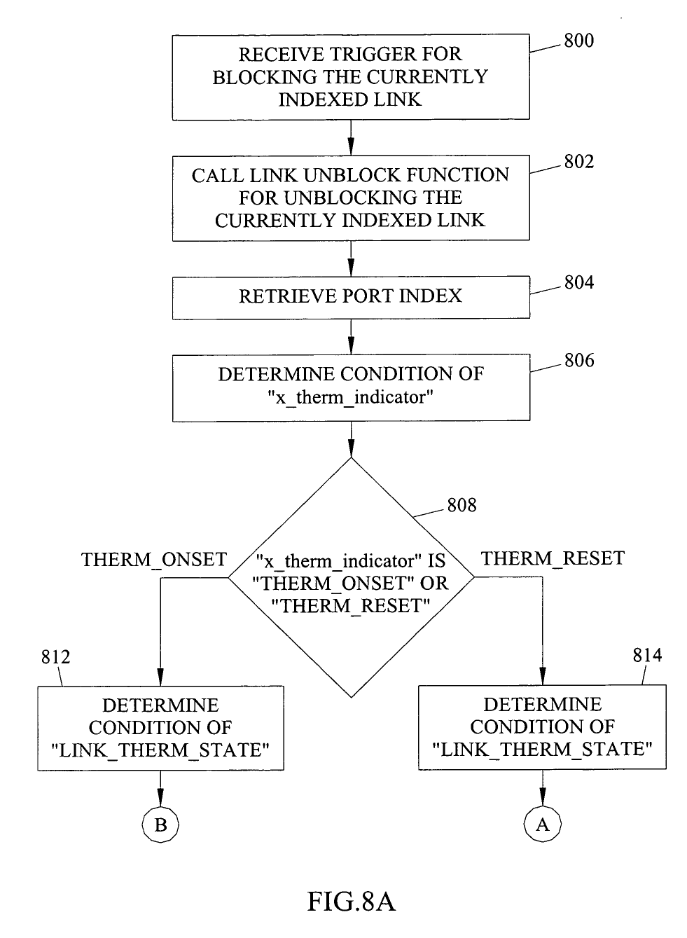

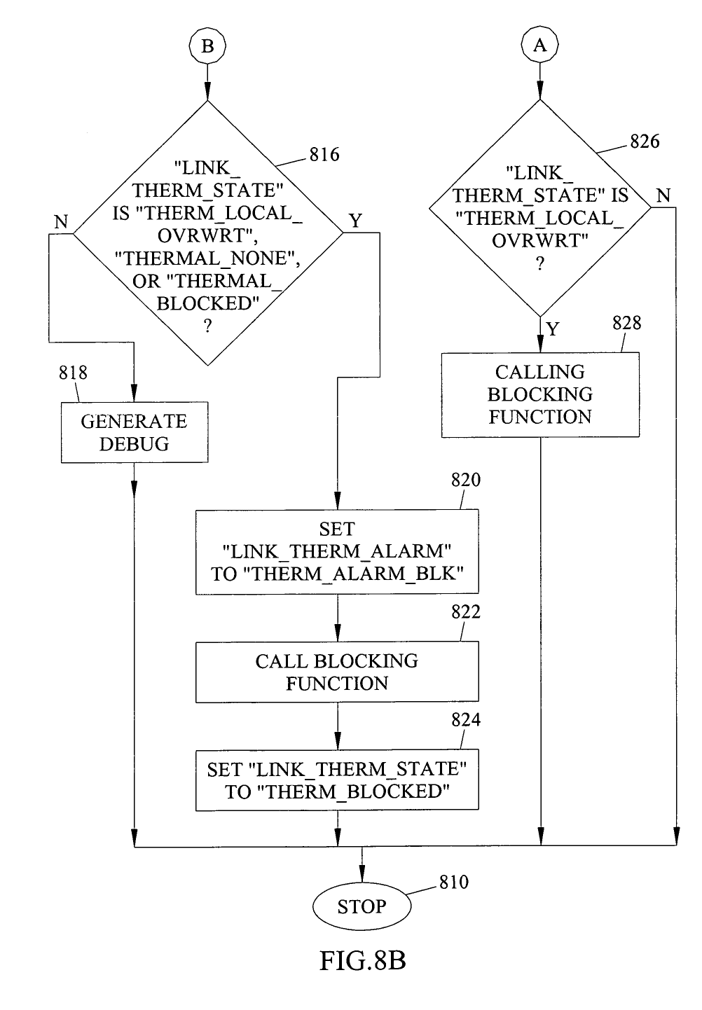

As stated above, unblocking function 214 can be called for unblocking a currently indexed link. When unblocking function 214 is called, the currently indexed link can be unblocked and associated thermal variables can be set. According to one embodiment, unblocking function 214 is called at step 622 of FIGS. 6A-6D. FIGS. 8A-8B are a flow chart illustrating a process implemented when unblocking function 214 is called according to one embodiment. Referring to FIG. 8A, the process for blocking a currently indexed link begins at step 800 where thermal management application 122 receives an L3 signal trigger calling unblocking function 214.

Next, at step 802, a link unblock function (“PMTC_UNBLOCK_LINK”) is called for blocking the currently indexed link. According to one embodiment, the link block function can block the link according to SS7 link changeover specifications. At step 804, the port index for the currently indexed link is retrieved.

At step 806, the condition of the “x_therm_indicator” parameter may be determined. It is determined whether the “x_therm_indicator” parameter is set to the “THERM_ONSET” condition or the “THERM_RESET” condition (step 808). If the “x_therm_indicator” parameter is not set to the “THERM_ONSET” condition or the “THERM_RESET” condition, the process proceeds to step 810 and stops. If the “x_therm_indicator” parameter is set to the “THERM_ONSET” condition, the process proceeds to step 812. If the “x_therm_indicator” parameter is set to the “THERM_RESET” condition, the process proceeds to step 814.

At step 812, the condition of the “LINK_THERM_STATE” parameter may be determined. It is determined whether the “LINK_THERM_STATE” parameter is set to “THERM_LOCAL_OVERWRT”, “THERMAL_NONE”, or “THERMAL_BLOCKED” (step 816 of FIG. 8B). If the “LINK_THERM_STATE” parameter is not set to “THERM_LOCAL_OVERWRT”, “THERMAL_NONE”, or “THERMAL_BLOCKED”, the condition is invalid and a debug output is generated (step 818 of FIG. 8B) and the process stops at step 810. The condition of “THERM_OVERWRT” indicates that the link which was thermally blocked is also now blocked by operator input. The condition of “THERMAL_NONE” indicates that the link is unblocked and an ONSET condition exists. The condition of “THERM_BLOCKED” indicates that the link which was thermally blocked is being blocked by an operator command.

If the “LINK_THERM_STATE” parameter is set to “THERM_LOCAL_OVERWRT”, “THERMAL_NONE”, or “THERMAL_BLOCKED”, the “LINK_THERM_ALARM” variable is set to “THERM_ALARM_BLK” (step 820). Next, at step 822, blocking function 212 is called and implemented as described herein. An example of the process of blocking function 212 is described with respect to FIG. 7. Next, the “LINK_THERM_STATE” variable is set to “THERM_BLOCKED” (step 824). The process then stops at step 810.

Referring to step 814, the condition of the “LINK_THERM_STATE” parameter is determined. Next, at step 826 of FIG. 8B, it is determined whether the condition of the “LINK_THERM_STATE” parameter is “THERM_LOCAL_OVRWRT”. If the condition of the “LINK_THERM_STATE” parameter is not “THERM_LOCAL_OVRWRT”, the process stops at step 810. Otherwise, if the condition of the “LINK_THERM_STATE” parameter is “THERM_LOCAL_OVRWRT”, blocking function 212 is called and implemented as described herein (step 828 of FIG. 8B) and then the process stops at step 810.

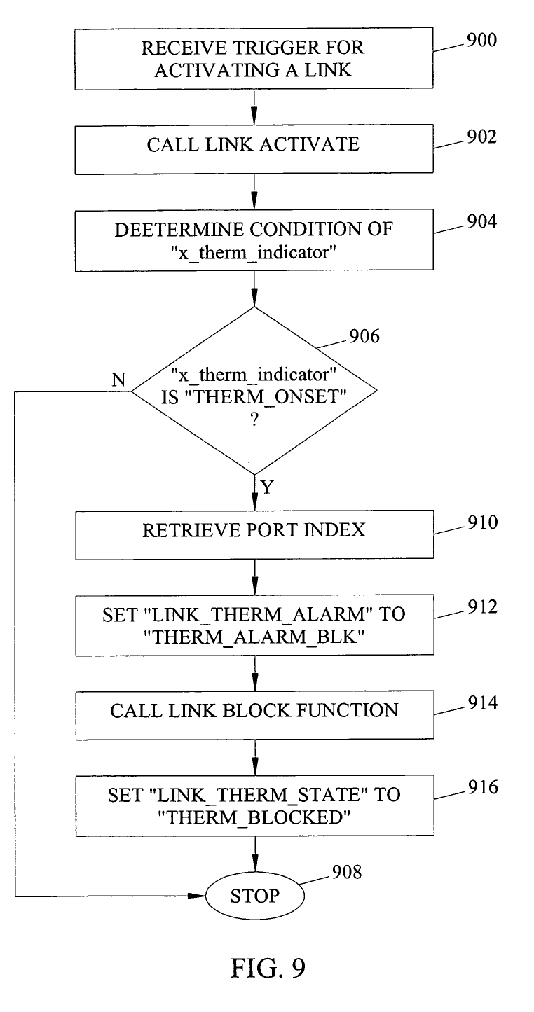

HCMIM 102 can include an activate link function 216 for preventing an operator from activating a thermally blocked link. Activate link function 216 can be called when SS7 management module 118 receives an L3 signal for activating a link. FIG. 9 is a flow chart illustrating a process implemented when module 118 receives the L3 signal for activating a link of HCMIM 102 according to one embodiment. Referring to FIG. 9, the process for activating a link begins at step 900 where SS7 management module 118 receives an L3 signal trigger calling activate link function 216.

Next, at step 902, a link activate function (“PMTC_ACTIVATE_LINK”) is called for activating the link. According to one embodiment, the link block function can block the link according to SS7 link changeover specifications.

At step 904, the condition of the “x_therm_indicator” parameter may be determined. It is determined whether the “x_therm_indicator” parameter for this link is set to the “THERM_ONSET” condition (step 906). If the “x_therm_indicator” parameter is not set to the “THERM_ONSET” condition, the process proceeds to step 908 and stops. If the “x_therm_indicator” parameter is set to the “THERM_ONSET” condition, the process proceeds to step 910.

At step 910, the port index for the currently indexed link is retrieved. Next, at step 912, the “LINK_THERM_ALARM” parameter is set to the “THERM_ALARM_BLK” condition. At step 914, blocking function 212 is called for blocking the currently indexed link. An exemplary process of blocking function 212 is described with respect to FIG. 7. Next, at step 916, the “LINK_THERM_STATE” parameter for the link is set to the “THERM_BLOCKED” condition. The process then stops at step 908.

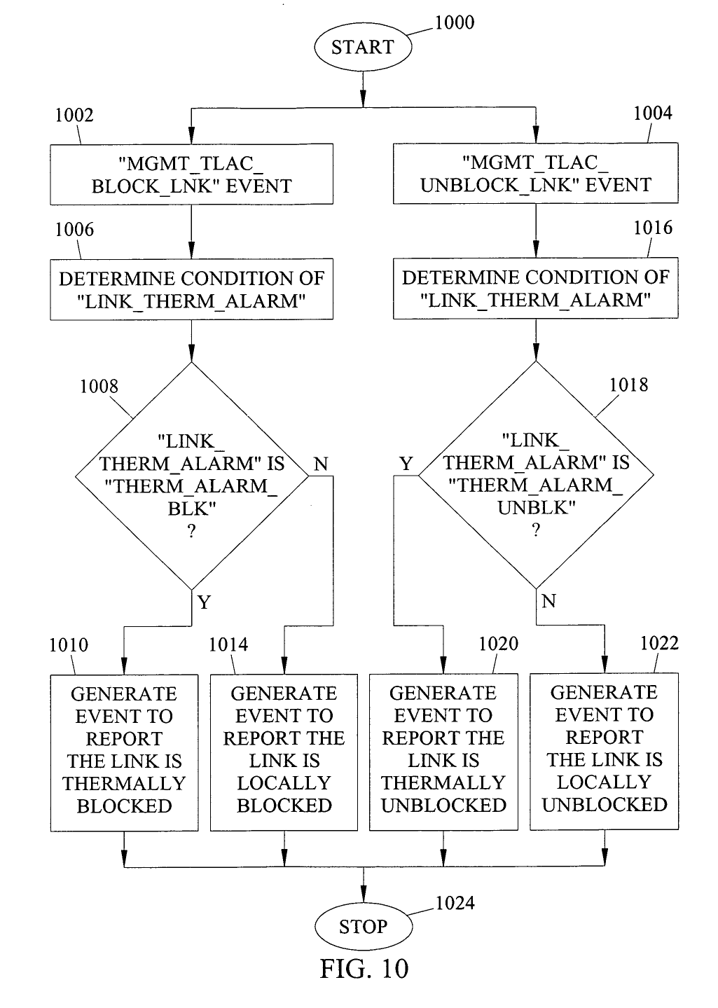

FIG. 10 is a flow chart illustrating a process for indicating to OAM 110 that a block or unblock has occurred according to an embodiment of the subject matter described herein. Referring to FIG. 10, the process can begin at step 1000 when a pass in message buffer for TLAC has information for a port to be processed on. Next, the process proceeds to step 1002 on a “MGMT_TLAC_BLOCK_LNK” event, or to step 1004 on a “MGMT_TLAC_UNBLOCK_LNK” event.

At step 1006, the condition of the “LINK_THERM_ALARM” parameter can be determined. Next, at step 1008, it can be determined whether the “LINK_THERM_ALARM” parameter is set to the “THERM_ALARM_BLK” condition. If the “LINK_THERM_ALARM” parameter is set to “THER_ALARM_BLK”, an event is generated for reporting that the link is thermally blocked (step 1010) and the process stops (step 1012). Otherwise, if the “LINK_THERM_ALARM” parameter is not “THER_ALARM_BLK”, an event is generated for reporting that the link is thermally blocked (step 1014) and the process stops (step 1012).

At step 1016, the condition of the “LINK_THERM_ALARM” parameter can be determined. Next, at step 1018, it can be determined whether the “LINK_THERM_ALARM” parameter is “THERM_ALARM_UNBLK”. If the “LINK_THERM_ALARM” parameter is “THER_ALARM_UNBLK”, an event is generated for reporting that the link is thermally unblocked (step 1020) and the process stops (step 1012). Otherwise, if the “LINK_THERM_ALARM” parameter is not “THER_ALARM_UNBLK”, an event is generated for reporting that the link is thermally unblocked (step 1014) and the process stops (step 1022). The process can stop at step 1024.

As described herein, the subject matter described herein can prevent or reduce the effect of the thermal shutdown on a network interface device. Particularly, the effect of the shutdown on message traffic to and from the network interface device can be prevented or reduced. According to one embodiment, the methods, systems, and computer program products described herein can be utilized for thermal management of a network interface. The method can include sending and receiving message traffic using a processor located on a first network interface. In addition, the method can include determining a temperature level associated with the processor. The method can also include switching message traffic from the first network interface to a second network interface in response to the temperature level of the processor having a predetermined relationship with respect to a threshold value, the threshold value being less than a thermal shutdown level of the processor.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for thermal management of a processor associated with a network interface, the method comprising:
(a) sending and receiving message traffic using a first processor associated with a first network interface;
(b) determining a temperature associated with the first processor; and
(c) switching the message traffic from the first processor to a second processor in response to the temperature associated with the first processor having a predetermined relationship with respect to a threshold value, the threshold value being less than a thermal shutdown level of the first processor.

2. The method of claim 1 wherein sending and receiving message traffic comprises sending and receiving message traffic over a signaling system 7 (SS7) link.

3. The method of claim 1 wherein sending and receiving message traffic comprises sending and receiving message traffic over an Internet protocol (IP) link.

4. The method of claim 1 wherein the first and second processors are located on the same network interface module.

5. The method of claim 1 wherein the first and second processors are located on different network interface modules.

6. The method of claim 1 wherein switching the message traffic to the second processor includes switching traffic to a second network interface associated with the second processor.

7. The method of claim 1 wherein the first network interface comprises a telecommunications signaling link interface for sending and receiving telecommunications signaling messages and wherein the first and second processors are configured to control the sending and receiving of the telecommunications signaling messages.

8. The method of claim 1 wherein the first network interface comprises an IP telephony network interface for sending and receiving voice packets over an IP network and wherein the first and second processors are configured to control the sending and receiving of the voice packets.

9. The method of claim 1 wherein switching the message traffic includes redirecting the message traffic from the first processor to the second processor in response to the temperature associated with the first processor being greater than the threshold value.

10. The method of claim 1 wherein step (c) comprises switching message traffic from the first processor to the second processor while the temperature of the first processor is greater than the threshold value.

11. The method of claim 1 comprising allowing provisioning links associated with the first network interface while the temperature associated with the first processor is greater than the threshold value and marking the links as unavailable for traffic.

12. The method of claim 1 comprising, after step (c), redirecting the message traffic from the second processor to the first processor in response to the temperature associated with the first processor being less than the threshold value.

13. The method of claim 12 comprising delaying of the switching of the message traffic from the second processor to the first processor for a predetermined time period after the temperature associated with the first processor falls below the threshold value.

14. The method of claim 1 comprising generating an alarm in response to the temperature associated with the first processor being greater than the threshold value.

15. A network communications device comprising:
(a) a first network interface for sending and receiving message traffic over a network;
(b) a first processor associated with the first network interface for controlling the sending and receiving of the message traffic over the first network interface;
(c) a second processor configured to control the sending and receiving of message traffic over a network;
(d) a temperature sensor for sensing a temperature associated with the first processor; and
(e) a thermal management application associated with the temperature sensor and the first processor for determining whether the temperature has a predetermined relationship with respect to a threshold value, and, in response to the temperature having a predetermined relationship with respect to the threshold value, switching the message traffic from the first processor to the second processor.

16. The network communications device of claim 15 wherein the first network interface sends and receives message traffic over a signaling system 7 (SS7) link.

17. The network communications device of claim 15 wherein the first network interface sends and receives message traffic over an Internet protocol (IP) link.

18. The network communications device of claim 15 wherein the first and second processors are located on the same network interface module.

19. The network communications device of claim 15 wherein the first and second processors are located on different network interface modules.

20. The network communications device of claim 15 comprising a second network interface associated with the second processor, wherein, in response to the temperature having the predetermined relationship with respect to the threshold value, the thermal management application is adapted to switch the message traffic from the first network interface to the second network interface.

21. The network communications device of claim 15 wherein the first network interface comprises a telecommunications signaling link interface for sending and receiving telecommunications signaling messages and wherein the first and second processors are configured to control the sending and receiving of the telecommunications signaling messages.

22. The network communications device of claim 15 wherein the first network interface comprises an IP telephony network interface for sending and receiving voice packets over an IP network and wherein the first and second processors are configured to control the sending and receiving of the voice packets.

23. The network communications device of claim 15 wherein the thermal management application is operable to redirect the message traffic from the first processor to the second processor in response to the temperature measured by the temperature sensor being greater than the threshold value.

24. The network communications device of claim 15 wherein the thermal management application is operable to switch message traffic from the first network interface to the second network interface while the temperature measured by the temperature sensor is greater than the threshold value.

25. The network communications device of claim 15 wherein the thermal management application is operable to allow an operator to provision links associated with the first network interface while the temperature measured by the temperature sensor is greater than the threshold value and to mark the links as unavailable for traffic.

26. The network communications device of claim 15 wherein the thermal management application is operable to redirect the message traffic from the second processor to the first processor in response to the temperature measured by the temperature sensor being less than the threshold value.

27. The network communications device of claim 26 wherein the thermal management application is operable to delay of the switching of the message traffic from the second processor to the first processor for a predetermined time period after the temperature measured by the temperature sensor falls below the threshold value.

28. The network communications device of claim 15 wherein the threshold value is less than thermal shutdown level of the processor.

29. The network communications device of claim 15 wherein thermal management application is adapted to generate an alarm in response to the temperature measured by the temperature sensor being greater than the threshold value.

30. A computer program product comprising computer executable instructions embodied in a computer readable medium for performing steps comprising:
(a) sending and receiving message traffic using a first processor associated with a first network interface;
(b) determining a temperature associated with the first processor; and
(c) switching the message traffic from the first processor to a second processor in response to the temperature associated with the first processor having a predetermined relationship with respect to a threshold value, the threshold value being less than a thermal shutdown level of the first processor.

31. The computer program product of claim 30 wherein the first and second processors are located on the same network interface module.

32. The computer program product of claim 30 wherein the first and second processors are located on different network interface modules.

33. The computer program product of claim 30 wherein switching the message traffic to the second processor includes switching traffic to a second network interface associated with the second processor.

34. The computer program product of claim 30 wherein the first network interface comprises a telecommunications signaling link interface for sending and receiving telecommunications signaling messages and wherein the first and second processors are configured to control the sending and receiving of the telecommunications signaling messages.

35. The computer program product of claim 30 wherein the first network interface comprises an IP telephony network interface for sending and receiving voice packets over an IP network and wherein the first and second processors are configured to control the sending and receiving of the voice packets.

36. The computer program product of claim 30 wherein switching the message traffic includes redirecting the message traffic from the first processor to the second processor in response to the temperature associated with the first processor being greater than the threshold value.

37. The computer program product of claim 30 wherein step (c) comprises switching message traffic from the first processor to the second processor while the temperature of the first processor is greater than the threshold value.

38. The computer program product of claim 30 comprising allowing provisioning links associated with the first network interface while the temperature associated with the first processor is greater than the threshold value and marking the links as unavailable for traffic.

39. The computer program product of claim 30 comprising, after step (c), redirecting the message traffic from the second processor to the first processor in response to the temperature associated with the first processor being less than the threshold value.

40. The computer program product of claim 39 comprising delaying of the switching of the message traffic from the second processor to the first processor for a predetermined time period after the temperature associated with the first processor falls below the threshold value.
